(19) United States
(12) Patent Application Publication
(10) Pub. No.: US 2024/0328787 A1
(43) Pub. Date: Oct. 3, 2024

(54) METHOD AND APPARATUS FOR NAVIGATION WITH GNSS-INS-EO SENSOR FUSION

(71) Applicant: Samsung Electronics Co., Ltd., Gyeonggi-do (KR)

(72) Inventor: Vincenzo CAPUANO, Playa Vista, CA (US)

(21) Appl. No.: 18/340,412

(22) Filed: Jun. 23, 2023

Related U.S. Application Data
(60) Provisional application No. 63/454,743, filed on Mar. 27, 2023.

(51) Int. Cl. G01C 21/16

(52) U.S. Cl. CPC G01C 21/1656; G01C 21/1652

(57) ABSTRACT

A method and an apparatus are provided that includes acquiring observations by one or more electro-optical (EO) sensors on a front-facing surface of a user equipment (UE). A processor of the UE extracts feature points from the observations expressed in a first coordinate frame of the UE. The processor matches the feature points to corresponding points of a model in a second coordinate frame of a user of the UE. The processor determines an integrated navigation solution in a third coordinate frame based on the matched feature points.

### CROSS-REFERENCE TO RELATED APPLICATION

This application claims the priority benefit under 35 U.S.C. § 119(e) of U.S. Provisional Application No. 63/454,743, filed on Mar. 27, 2023, the disclosure of which is incorporated by reference in its entirety as if fully set forth herein.

### TECHNICAL FIELD

The disclosure generally relates to navigation using a user equipment (UE) or smartphone device. More particularly, the subject matter disclosed herein relates to improvements to navigation using electro-optical (EO) sensors of the UE or smartphone device.

### SUMMARY

By embedding various sensors with powerful computing and storage capabilities in small communication devices, smartphone devices have become a prominent platform for navigation. State of the art navigation systems and methods using a smartphone device are predominantly based on global navigation satellite system (GNSS) measurements. Advanced solutions provided by smartphone devices are typically based on a fusion of measurements from a GNSS and a micro electro-mechanical system (MEMS) (a type of inertial navigation system (INS)). For example, a sequential estimator, such as a Kalman filter, may be used that propagates position, velocity, and attitude by integrating accelerometer and gyroscope measurements and correcting them with GNSS observations (e.g., pseudoranges and pseudorange rates). Other proposed solutions include the additional fusion of magnetometer and/or barometer measurements to increase attitude observability and estimation accuracy.

While the additional attitude information of a magnetometer and a barometer may be beneficial, the use of low-cost and low-performance MEMS sensors built in a smartphone device, or of approximated models of user dynamics, may result in poor navigation performance, particularly when combined with measurements resulting from poor GNSS conditions.

To solve this problem, other methods and systems have been proposed that use images of the environment where the user is navigating in addition to GNSS and MEMS, and in some architectures magnetometer and/or barometer measurements. The images of the environment are collected by a main rear-facing camera of the smartphone device, on a surface opposite that of a display of the smartphone device. The images may be used to estimate the pose of the smartphone device with the respect to a world frame through a model based approach. The images may also be used to simultaneously map an environment where the user is navigating, while estimating the pose of the smartphone device with the respect to the same environment. These approaches may be referred to as GNSS-INS-rear-facing camera fusion.

One issue with the above approach is that in order to improve the estimation of position, velocity, and orientation of the smartphone device through the processing of images of the environment, the rear facing camera of the smartphone device must point toward to the environment, which can be inconvenient for the user during navigation while walking or driving.

Another issue with the above approach is that processing the images of the environment helps determine the pose of the smartphone device with respect to the environment, and not the pose of the user with respect to the environment. Generally, the purpose of using a smartphone device for navigation is to determine position, velocity, and orientation of the user (instead of the smartphone) with respect to the environment.

To overcome these issues, systems and methods are described herein that utilize front-facing EO sensors, such as, for example, a commonly available visible camera or a more sophisticated EO sensor, which are typically embodied on a display surface of the smartphone device for other primary purposes.

The above approaches improve on previous methods because they assist in finding the position, velocity, and orientation of the user coordinate frame in a world navigation coordinate frame together with full observability of the transformation between the smartphone coordinate frame and the user coordinate frame to further improve navigation performance.

In an embodiment, a method includes acquiring observations by one or more EO sensors on a front-facing surface of a UE. A processor of the UE extracts feature points from the observations expressed in a first coordinate frame of the UE. The processor matches the feature points to corresponding points of a model in a second coordinate frame of a user of the UE. The processor determines an integrated navigation solution in a third coordinate frame based on the matched feature points.

In an embodiment, a UE includes a front-facing surface, and one or more EO sensors on the front-facing surface of the UE acquiring observations. The UE also includes one or more INS devices outputting inertial measurements of the UE in a first coordinate frame of the UE. The UE further includes a processor configured to extract feature points from the observations expressed in the first coordinate frame, and match the feature points to corresponding points of a model in a second coordinate frame of a user of the UE. The processor may also be configured to determine an integrated navigation solution in a third coordinate frame based on the matched feature points.

In an embodiment, a UE is provided that includes a processor and a non-transitory computer readable storage medium storing instructions. When executed the instructions cause the processor to control one or more EO sensors on a front-facing surface of the UE to acquire observations. The instructions also cause the processor to extract feature points from the observations expressed in a first coordinate frame of the UE, and match the feature points to corresponding points of a model in a second coordinate frame of a user of the UE. The instructions further cause the processor to determine an integrated navigation solution in a third coordinate frame based on the matched feature points.

### BRIEF DESCRIPTION OF THE DRAWING

In the following section, the aspects of the subject matter disclosed herein will be described with reference to exemplary embodiments illustrated in the figures, in which:

FIG. 1 is a diagram illustrating different relative frames for a navigation system, according to an embodiment;

FIG. 2 is a diagram illustrating INS-GNSS integration in a smartphone navigation system;

FIG. 3 is a diagram illustrating INS-GNSS-rear-facing camera fusion in a smartphone navigation system;

FIG. 4 is a diagram illustrating EO sensor integration in a smartphone navigation system, according to an embodiment;

FIG. 5 is a diagram illustrating EO sensor integration in a smartphone navigation system, according to another embodiment;

FIG. 6 is a flowchart illustrating a method for performing navigation by a smartphone device, according to an embodiment; and

FIG. 7 is a block diagram of an electronic device in a network environment, according to an embodiment.

### DETAILED DESCRIPTION

In the following detailed description, numerous specific details are set forth in order to provide a thorough understanding of the disclosure. It will be understood, however, by those skilled in the art that the disclosed aspects may be practiced without these specific details. In other instances, well-known methods, procedures, components and circuits have not been described in detail to not obscure the subject matter disclosed herein.

Reference throughout this specification to “one embodiment” or “an embodiment” means that a particular feature, structure, or characteristic described in connection with the embodiment may be included in at least one embodiment disclosed herein. Thus, the appearances of the phrases “in one embodiment” or “in an embodiment” or “according to one embodiment” (or other phrases having similar import) in various places throughout this specification may not necessarily all be referring to the same embodiment. Furthermore, the particular features, structures or characteristics may be combined in any suitable manner in one or more embodiments. In this regard, as used herein, the word “exemplary” means “serving as an example, instance, or illustration.” Any embodiment described herein as “exemplary” is not to be construed as necessarily preferred or advantageous over other embodiments. Additionally, the particular features, structures, or characteristics may be combined in any suitable manner in one or more embodiments. Also, depending on the context of discussion herein, a singular term may include the corresponding plural forms and a plural term may include the corresponding singular form. Similarly, a hyphenated term (e.g., “two-dimensional,” “pre-determined,” “pixel-specific,” etc.) may be occasionally interchangeably used with a corresponding non-hyphenated version (e.g., “two dimensional,” “predetermined,” “pixel specific,” etc.), and a capitalized entry (e.g., “Counter Clock,” “Row Select,” “PIXOUT,” etc.) may be interchangeably used with a corresponding non-capitalized version (e.g., “counter clock,” “row select,” “pixout,” etc.). Such occasional interchangeable uses shall not be considered inconsistent with each other.

Also, depending on the context of discussion herein, a singular term may include the corresponding plural forms and a plural term may include the corresponding singular form. It is further noted that various figures (including component diagrams) shown and discussed herein are for illustrative purpose only, and are not drawn to scale. For example, the dimensions of some of the elements may be exaggerated relative to other elements for clarity. Further, if considered appropriate, reference numerals have been repeated among the figures to indicate corresponding and/or analogous elements.

The terminology used herein is for the purpose of describing some example embodiments only and is not intended to be limiting of the claimed subject matter. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that when an element or layer is referred to as being on, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

The terms “first,” “second,” etc., as used herein, are used as labels for nouns that they precede, and do not imply any type of ordering (e.g., spatial, temporal, logical, etc.) unless explicitly defined as such. Furthermore, the same reference numerals may be used across two or more figures to refer to parts, components, blocks, circuits, units, or modules having the same or similar functionality. Such usage is, however, for simplicity of illustration and ease of discussion only; it does not imply that the construction or architectural details of such components or units are the same across all embodiments or such commonly-referenced parts/modules are the only way to implement some of the example embodiments disclosed herein.

Unless otherwise defined, all terms (including technical and scientific terms) used herein have the same meaning as commonly understood by one of ordinary skill in the art to which this subject matter belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used herein, the term “module” refers to any combination of software, firmware and/or hardware configured to provide the functionality described herein in connection with a module. For example, software may be embodied as a software package, code and/or instruction set or instructions, and the term “hardware,” as used in any implementation described herein, may include, for example, singly or in any combination, an assembly, hardwired circuitry, programmable circuitry, state machine circuitry, and/or firmware that stores instructions executed by programmable circuitry. The modules may, collectively or individually, be embodied as circuitry that forms part of a larger system, for example, but not limited to, an integrated circuit (IC), system on-a-chip (SoC), an assembly, and so forth.

As described here, the term “smartphone device” is used interchangeably with the terms “smartphone”, “electronic device”, “user device”, “user equipment”, “UE”, “user terminal”, and “terminal”.

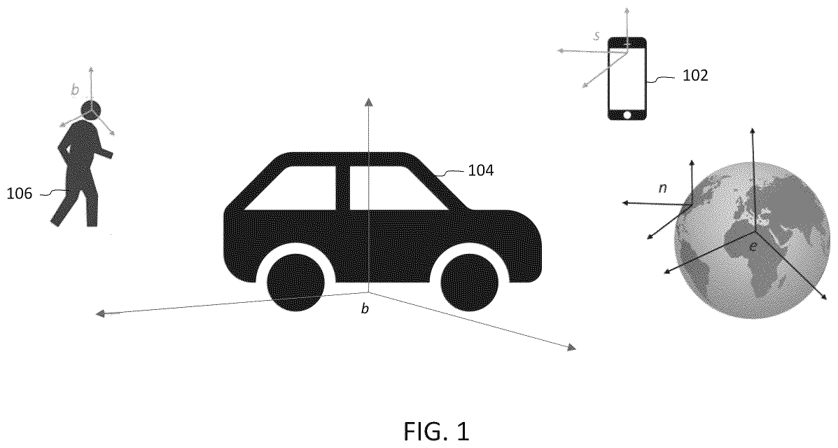

FIG. 1 is a diagram illustrating different relative frames for a navigation system. Embodiments of the disclosure may be used to find position, velocity, and orientation of a user body coordinate frame b in a world navigation coordinate frame (e.g., local navigation coordinate frame n or earth-centered earth-fixed coordinate frame e), by using a measurement collected in a coordinate frame e and in a coordinate frame s of a smartphone device 102. The user body coordinate frame b may be the coordinate frame of a vehicle 104 in the case of automotive navigation, or the coordinate frame of a person 106 in the case of pedestrian navigation.

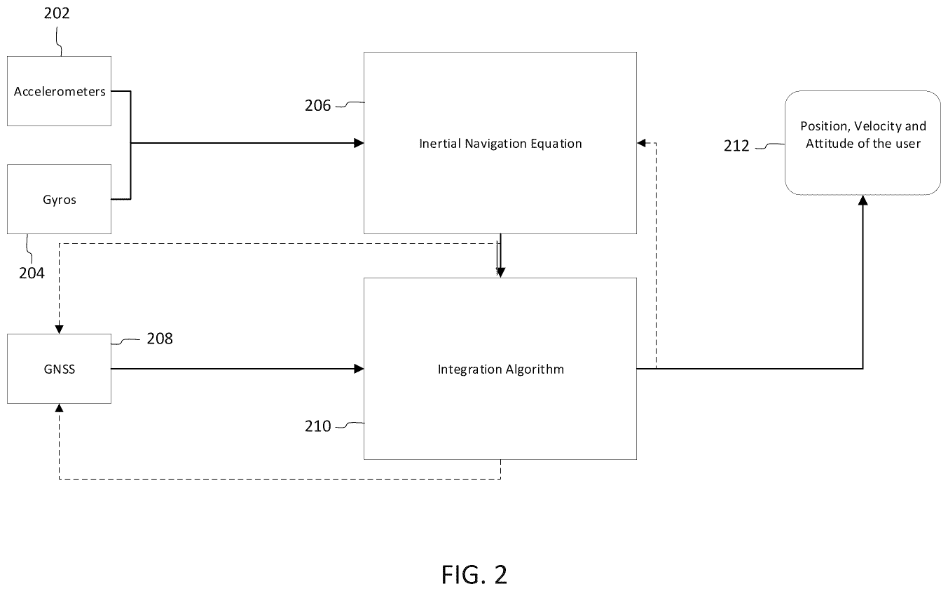

FIG. 2 is a diagram illustrating INS-GNSS integration in a smartphone navigation system. Accelerometers 202 and gyroscopes 204 may provide measurements (e.g., INS measurements of acceleration and angular rates) to an inertial navigation equations block 206. The inertial navigation equations block 206 may use the measurements to propagate navigation states, including position, velocity, and attitude, of the smartphone device. The navigation states may be an inertial navigation solution.

A GNSS block 208 provides GNSS navigational measurements to an integration algorithm block 210. The GNSS navigational measurements may be position and velocity estimates in a loose integration architecture, or pseudorange (code phase and/or carrier phase) and pseudorange rate estimates in a tight integration architecture. The smartphone device may also include a magnetometer and a barometer that may be used in determining part of the navigational measurements. The navigational measurements are used to correct the inertial navigation solution, which is provided to the integration algorithm block 210 from the inertial navigation equations block 206. The inertial navigation solution may also be provided as feedback to the GNSS block 208.

The integration algorithm block 210 outputs an integrated algorithm solution that may include a position, a velocity, and an attitude of the user at 212. This integrated algorithm solution may also be provided as feedback to the inertial navigation equations block 206 and the GNSS block 208.

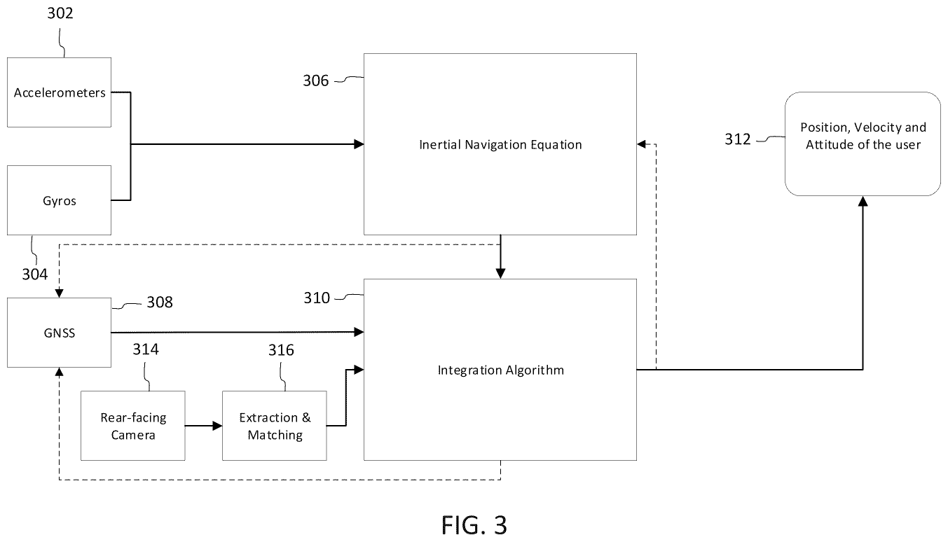

FIG. 3 is a diagram illustrating INS-GNSS-rear facing camera fusion in a smartphone navigation system. Accelerometers 302, gyroscopes 304, inertial navigation equations block 306, and GNSS block 308 function in a manner similar to that described above for the corresponding blocks of FIG. 2. A rear-facing camera 314 provides images to a feature extraction and matching block 316, which extracts feature points from the images of the surrounding environment acquired by the rear-facing camera 318, and matches those feature points to a stored model. The rear-facing camera may be disposed on a surface of the smartphone device opposite that of a main display of the smartphone device.

The resulting feature points are provided to an integration algorithm block 310, along with navigational measurements from the GNSS block 308 and an inertial navigation solution from the inertial navigation equation block 306, to generate an integrated navigation solution, which may include a position, a velocity, and an attitude of the user at 312. The integrated navigation solution may also be provided as feedback to the inertial navigation equations block 306 and the GNSS block 308.

Measurements collected by the smartphone (e.g., INS measurements in the coordinate frame s and GNSS measurements in the coordinate frame e) may be augmented by adding motion constraints of the user body coordinate frame b in the user body coordinate frame b. These constraints are also known as non-holonomic constraints (NHC).

Since the INS measurements are in the smartphone coordinate frame s, and the GNSS measurements are in the world navigation frame e, the position, velocity and orientation of the smartphone coordinate frame s may be estimated in the world navigation coordinate frame n or e. However, the position, velocity, and orientation of the user coordinate frame b may not be estimated in the world navigation frame n or e, unless a transformation (R|T) of the smartphone coordinate frame s into the user coordinate frame b is also estimated.

In order to exploit the motion constraints defined in the user body coordinate frame b. they may be converted to be expressed in the smartphone coordinate frame s, or the measurements collected in the smartphone coordinate frame s may be transformed to be expressed in the user body coordinate frame b.

Embodiments of the disclosure provide a method to jointly estimate the transformation (R|T) between the smartphone coordinate frame s and the user body coordinate frame b, together with position, velocity, and orientation of the user body coordinate frame b in the world navigation coordinate frame n or e. This method may be performed using the available sensors embodied in the smartphone device primarily for navigation (e.g., GNSS and INS), which provide measurements in the world navigation frame e and in the smartphone coordinate frame s; front-facing EO sensors generally integrated in the smartphone device for other primary purposes (e.g., performing facial recognition or taking photos), which provide measurements in the smartphone coordinate frame s, and motion constraints defined in the user body coordinate frame b, which are equivalent to virtual measurements in the user body coordinate frame b.

Specifically, a system and method are provided for determining the position, velocity, and orientation of a user (e.g., a pedestrian or an automotive vehicle) using a smartphone device with respect to local navigation coordinate frame n or earth-centered earth-fixed coordinate frame e objects in an operational space.

Embodiments of the disclosure provide a tight fusion of first and second subsystems for the purpose of improving navigational accuracy. The first subsystem may include available sensors embodied in the smartphone device primarily for navigation, such as, for example, GNSS sensors, INS sensors, a magnetometer, and a barometer. The second subsystem may include the EO sensors that are generally integrated in the smartphone device for other primary purposes.

For pedestrian navigation, in addition to GNSS and INS measurements, measurements collected by front-facing EO sensors are used to estimate a pose of the smartphone device with the respect to the face of the user. For automotive navigation, the front-facing EO sensors are used to estimate the pose of the smartphone device with respect to the interior of the car. The pose may be determined as a transformation between a set of points extracted from the EO measurements and corresponding points of a model of either the face of the user or the interior of the car. The model may be created and stored in the smartphone device when initially setting up the smartphone device in a manner similar to enabling face ID and face authentication. This enables pose estimation with model-based approaches. The model may also be simultaneously created while estimating the pose through a simultaneous localization and mapping (SLAM) approach.

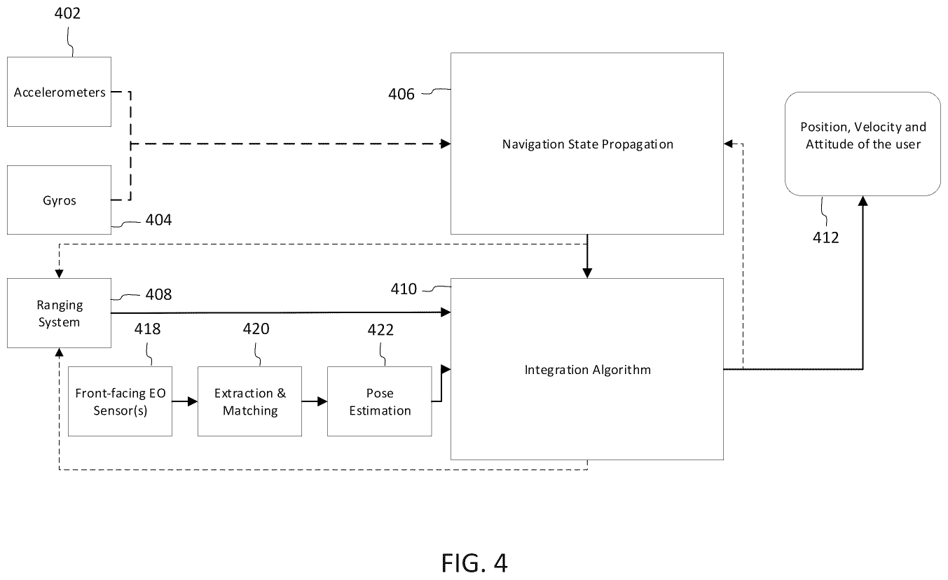

FIG. 4 is a diagram illustrating EO sensor integration in a smartphone navigation system, according to an embodiment. Accelerometers 402 and gyroscopes 404 of a smartphone device may provide measurements (e.g., INS measurements of acceleration and angular rates) in smartphone coordinate frame s to a navigation state propagation block 406. The navigation state propagation block 406 may use the measurements to propagate navigation states, including position, velocity, and attitude, of the smartphone device in a local coordinate frame n or an earth-centered earth-fixed coordinate frame e. These navigation states may be a predicted navigation solution.

As described above, a translational dynamics model (using forces and accelerations) and a rotational kinematic model (using angular rates) may use measurements from the accelerometers 402 and the gyroscopes 404 as input. However, embodiments are not limited to the use of accelerometers and gyroscopes, and these models may use translational or rotational measurements from any sensor. Additionally, the models may instead use a pure mathematical model without using any measurements as input.

In another embodiment, a navigation propagator or dead reckoning system may be used in the navigation state propagation block 406, without input from the accelerometers 402 and the gyroscopes 404. A dynamic (or kinematic) propagator estimates a current navigation state (position, velocity, and orientation) from a previous navigation state through a model of dynamics (or kinematics).

A ranging system block 408 provides navigational measurements in a world navigation coordinate frame to an integration algorithm block 410, which also receives the predicted navigation solution from the navigation state propagation block 406. The predicted navigation solution may also be provided as feedback to the ranging system block 408. The ranging system block 408 may be embodied as a GNSS, which provides navigational measurements of position and velocity estimates or GNSS raw measurements. The navigational measurements are used to correct the predicted navigation solution. The smartphone device may also include magnetometers and/or barometers that may be used in determining part of the navigational measurements.

Other ranging systems may be used in place of the GNSS including, for example, ultra-wideband (UWB) and WiFi (indoors), each of which would result in a different type of ranging measurement.

Front-facing EO sensors 418 of the smartphone device provide acquired observations and/or images to a feature extraction and matching block 420, which extracts feature points from acquired observations and/or images in smartphone coordinate frame s, and matches the extracted feature points to corresponding points of a model in user body coordinate frame b, as described above. The front-facing EO sensors are disposed on a front surface of the smartphone device, which may also include a main display of the smartphone device.

The feature extraction and matching block 420 provides the matched feature points to a pose estimation block 422, which determines a pose transformation between smartphone coordinate frame s and user body coordinate frame b. In a loose integration architecture, the pose transformation is also part of the navigational measurement and is provided to the integration algorithm block 410.

The integration algorithm block 410 uses the EO-based pose estimation between coordinate frames s and b, in combination with motion constraints in user body coordinate frame b, along with the predicted navigation solution, to output an integrated navigation solution including a position, a velocity, and an attitude of the user, at 412. Additionally, the integrated navigation solution may include INS biases (if INS is used) and ranging system clock bias and drift (e.g., receiver clock bias and drift if GNSS is used). This integrated navigation solution may be provided as feedback to the navigation state propagation block 406 and the ranging system block 408. In an alternate embodiment, the system of FIG. 4 may operate without the use of motion constraints.

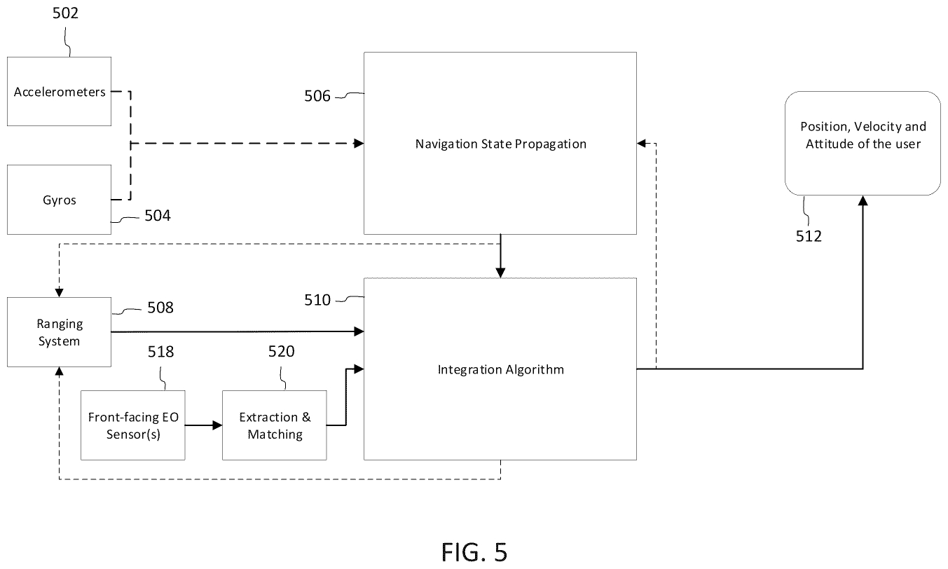

FIG. 5 is a diagram illustrating EO sensor integration in a smartphone navigation system, according to another embodiment. In a tight integration architecture, the pose of smartphone coordinate frame s with respect to user body coordinate frame b may be included as part of the state, and the raw EO measurements (extracted and matched feature points) may be used as navigational measurements in determining the integrated navigation solution.

Specifically, FIG. 5 differs from FIG. 4 in that the output of a feature extraction and matching block 520 is a direct input to an integration algorithm block 510. The pose is jointly estimated in the integration algorithm block 510 together with other components of the state. Feature points extracted in the smartphone coordinate frame s are matched with points of a model in the user body coordinate frame b, and are combined with motion constraints in user body coordinate frame b in the integration algorithm block 510. In an alternate embodiment, the system of FIG. 5 may operate without the use of motion constraints.

Similar to FIG. 4, accelerometers 502 and gyroscopes 504 of the smartphone device may be used to propagate navigation states (e.g., position, velocity, and attitude in smartphone frame s) from a navigation state propagation block 506 in world coordinate frame n or e, as a predicted navigation solution. A ranging system block 508 provides navigational measurements in smartphone coordinate frame s to the integration algorithm block 510, which also receives the predicted navigation solution from the navigation state propagation block 506. The predicted navigation solution may be provided as feedback to the ranging system block 508. When the ranging system is a GNSS, the navigational measurements may be pseudorange and pseudorange rate estimates or a position and velocity of the smartphone coordinate frame s. The navigational measurements are used to correct the predicted navigation solution at the navigation state propagation block 510.

The integration algorithm block 510 uses the feature points in combination with the motion constraints in user body coordinate frame b, along with the predicted navigation solution, to output an integrated navigation solution including a position, a velocity, and an attitude of the user, at 512. The integrated navigation solution may also include a pose transformation between smartphone coordinate frame s and user body coordinate frame b. Additionally, the integrated navigation solution may include output INS biases and GNSS receive clock bias and drift. The integrated navigation solution may also be provided as feedback to the navigation state propagation block 506 and the ranging system block 508.

As described above with respect to FIG. 4, the translational dynamics model and the rotational kinematic model may use translational or rotational measurements from any type of sensor, or may use a pure mathematical model without any measurement inputs. Further, a navigation propagator or dead reckoning system may be used in the navigation state propagation block 506, without input from the accelerometers 402 and the gyroscopes 404.

Additionally, as described above with respect to FIG. 4, other ranging systems may be used in place of the GNSS including, for example, UWB and WiFi (indoors), each of which would result in a different type of ranging measurement.

According to another embodiment, the systems of FIGS. 4 and 5 may function without the use of the navigation state propagation block 406, 506, and thus, also accelerometers 402, 502, and gyroscopes 404, 504. In such a system, the integration algorithm block 410, 510 uses input from the ranging system 408, 508 and the front-facing EO sensors 418, 518 in determining the integrated navigation solution.

In another embodiment, the systems of FIGS. 4 and 5 may function without the use of the ranging system 408, 508. In such a system, the integration algorithm block 410, 510, uses input from the navigation state propagation block 406, 506 and the front-facing EO sensors 418, 518 in determining the integrated navigation solution.

Instead of relying on a stored model of 3D points of the target (either the face of the pedestrian user or the interior of an automotive vehicle), this model may be simultaneously estimated and refined while estimating the position, velocity, and attitude of the user, in a SLAM approach. In this case, a map of 3D points may also be output as part of the estimated state at 512.

Herein, EO measurements collected by the front-facing EO sensors of the smartphone device are utilized rather than the images collected by the rear-facing camera of the smartphone device in GNSS-INS-rear-facing camera fusion.

In the GNSS-INS-rear-facing camera fusion approach, the rear-facing camera points toward the environment where the user is navigating. For example, in the case of pedestrian navigation, the walking or running person would have to hold the phone in such a way that the rear-facing camera can acquire images of the urban surrounding. This may not be practical while simultaneously facing the screen to follow the indicated walking directions. Similarly, in the case of automotive navigation, the smartphone device would have to be mounted using a phone holder in such a way that the rear-facing camera is not obstructed and can acquire images of the surroundings, and therefore, with a certain orientation that allows the camera to see through one of the car windows. This approach may not work if the smartphone device is located in an arbitrary location inside the vehicle with an arbitrary orientation.

Herein, the front-facing EO sensors are used to estimate the smartphone device pose with respect to the user, and for this purpose the front-facing EO sensors (and screen) point toward the user. In the case of pedestrian navigation, the smartphone device is usually held so that the user can see the screen, and accordingly, the front-facing EO sensors of the front part of the phone will also point toward the user, allowing feature extraction and matching and EO pose estimation of the smartphone device with the respect to the user. In the case of automotive navigation, the smartphone device may be in any location and orientation inside the vehicle as long as the screen (and the front-facing EO sensors) are not obstructed and face the user or the interior of the car (e.g., windows, seats, ceiling).

Accordingly, measurements collected by the front-facing EO sensors of the smartphone device are used to estimate the pose of the user body coordinate frame b with the respect to the smartphone coordinate frame s. The pose transformation between these two coordinate frames allows it to transform the measurements collected in the smartphone coordinate frame s to their equivalent in the user body coordinate frame b, in which motion constraints are defined based on the user type (an automotive vehicle or a pedestrian). The pose transformation between these two frames may also allow it to transform the motion constraints formulated in the user body coordinate frame b to their equivalent in the smartphone coordinate frame s. Herein, the transformation pose between the two coordinate frames is part of the navigation filter state, estimated with the other navigation states.

Regarding the front-facing EO sensors 424 and 524 of FIGS. 4 and 5, a front-facing EO sensor may be embedded as a simple monocular camera facing a certain target, or any combination of EO sensors. The target may be a face of a pedestrian user and/or a part of the interior of a car.

In the case of the front-facing EO sensor being adopted as a simple monocular camera, in the feature extraction and matching performed at blocks 426 and 526 of FIGS. 4 and 5, a set of feature points rigidly connected to the user body coordinate frame b expressed in the smartphone coordinate frame s are extracted from acquired images of the user and matched to corresponding 3D points of a stored model of the user expressed in the user body coordinate frame b.

The pose of the smartphone coordinate frame s with respect to the user body coordinate frame b and vice versa can be found, for example, by solving the perspective-n-point (PnP) problem. The PnP problem estimates the relative pose (six degrees of freedom) between an object and the camera, given a set of correspondences between 3D points and their projections on the image plane. A commonly used solution to the problem exists for n=3 (P3P), and many solutions are available for the general case of n≥3. Alternatively, it may also be possible to use a learning-based method to determine the pose of a target with respect to the camera given an image of the target acquired by the same camera.

Therefore, in the loose integration architecture of FIG. 4, the pose of the smartphone coordinate frame s with the respect to the user body coordinate frame b, and vice versa, may be separately estimated using the front camera and as external measurement fed to the system to allow for usage of motion constraints in the frame s, and vice versa, to estimate the navigation solution in the frame b.

However, most advanced and modern smartphone devices are equipped with front-facing EO sensors that are more sophisticated than a monocular camera. For example, a system for facial recognition may include a set of regular cameras, infrared cameras, various sensors, and a dot projector, which work together to create a 3D map of the facial structure of the user.

In addition to recognizing the face of the user to unlock the screen, by matching a set of detected points with a set of points of a 3D model, the same system may also be used to find the transformation between the two sets of points, which is the attitude of the smartphone device with respect to the face of the user, which is also the attitude between the smartphone coordinate frame s and the user body coordinate frame b. Such systems are expected to be embodied in most smartphone devices so that they may be efficiently used in poor illumination conditions (e.g., through the use of infrared images).

Using alternative front-facing EO sensors, rather than a front-facing visible camera, may reduce power consumption and data storage. Indeed, visible images acquired by the front-facing camera may have a higher resolution than the observations provided by these other front-facing EO sensors, therefore processing them results in a higher computational burden and larger data storage.

Using measurements from multiple sensors may be advantageous, as different information can be synergistically fused, balancing the strengths of different sensors to improve the navigation performance that each sensor would provide individually.

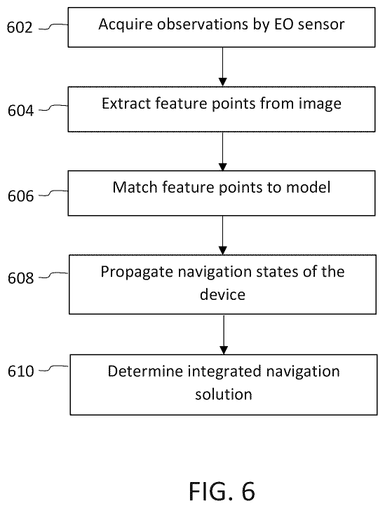

FIG. 6 is a flowchart illustrating a method for performing navigation by a smartphone device, according to an embodiment. At 602, one or more EO sensors on a front-facing surface of a smartphone device acquire observations. The front-facing surface may also include a main display of the smartphone device.

At 604, feature points are extracted from the observations expressed in a first coordinate frame of the smartphone device. At 606, the feature points are matched to corresponding points of a model in a second coordinate frame of a user of the smartphone device. The model may be a 3D model of a face of the user or an interior of a vehicle, and the 3D model may be prestored prior to capturing the image or estimated in a SLAM approach after capturing the image. A pose transformation between the first coordinate frame and the second coordinate frame may be determined based on the matched feature points and be the output of 606.

At 608, navigation states are propagated using inertial measurements from one or more INS devices of the UE. The navigation states may include a position, a velocity, and an attitude of the smartphone device in a third coordinate frame. The one or more INS devices may include at least one of an accelerometer and a gyroscope.

At 610, an integrated navigation solution is determined in the second coordinate frame based on the propagated navigation states, the matched feature points, and motion constraints of the user in the second coordinate frame. The integrated navigation solution may also be determined based on GNSS navigational measurements. The integrated navigation solution may include a position, a velocity, and an attitude of the user of the smartphone device. The integrated navigation solution may also include INS biases, GNSS receive clock bias and drift, pose transformation between the first coordinate frame and the second coordinate frame (if not output at 606), and a map of the environment (if not prestored prior to capturing the image).

The navigational measurements are used to correct the navigation state propagated through the INS measurements. INS measurements of acceleration and angular rate of the user may be collected by accelerometers and gyroscopes, respectively, of the smartphone.

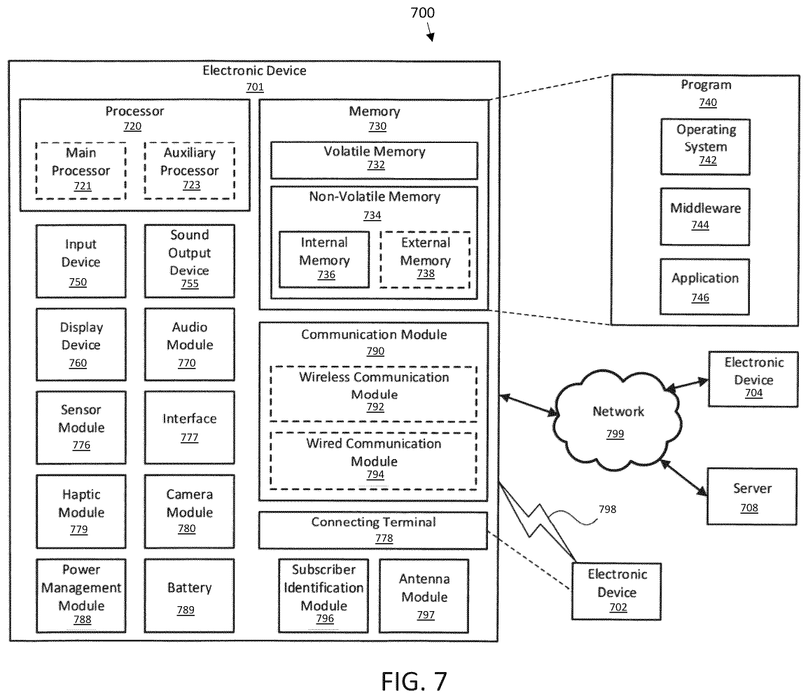

FIG. 7 is a block diagram of an electronic device in a network environment 700, according to an embodiment. The electronic device of FIG. 7 may be embodied as the smartphone device or UE described above.

Referring to FIG. 7, an electronic device 701 in a network environment 700 may communicate with an electronic device 702 via a first network 798 (e.g., a short-range wireless communication network), or an electronic device 704 or a server 708 via a second network 799 (e.g., a long-range wireless communication network). The electronic device 701 may communicate with the electronic device 704 via the server 708. The electronic device 701 may include a processor 720, a memory 730, an input device 740, a sound output device 755, a display device 760, an audio module 770, a sensor module 776, an interface 777, a haptic module 779, a camera module 780, a power management module 788, a battery 789, a communication module 790, a subscriber identification module (SIM) card 796, or an antenna module 794. In one embodiment, at least one (e.g., the display device 760 or the camera module 780) of the components may be omitted from the electronic device 701, or one or more other components may be added to the electronic device 701. Some of the components may be implemented as a single integrated circuit (IC). For example, the sensor module 776 (e.g., a fingerprint sensor, an iris sensor, or an illuminance sensor) may be embedded in the display device 760 (e.g., a display).

The processor 720 may execute software (e.g., a program 740) to control at least one other component (e.g., a hardware or a software component) of the electronic device 701 coupled with the processor 720 and may perform various data processing or computations.

As at least part of the data processing or computations, the processor 720 may load a command or data received from another component (e.g., the sensor module 746 or the communication module 790) in volatile memory 732, process the command or the data stored in the volatile memory 732, and store resulting data in non-volatile memory 734. The processor 720 may include a main processor 721 (e.g., a central processing unit (CPU) or an application processor (AP)), and an auxiliary processor 723 (e.g., a graphics processing unit (GPU), an image signal processor (ISP), a sensor hub processor, or a communication processor (CP)) that is operable independently from, or in conjunction with, the main processor 721. Additionally or alternatively, the auxiliary processor 723 may be adapted to consume less power than the main processor 721, or execute a particular function. The auxiliary processor 723 may be implemented as being separate from, or a part of, the main processor 721.

The processor 720 may perform the operations of the smartphone device described above with respect to FIGS. 2-6.

The auxiliary processor 723 may control at least some of the functions or states related to at least one component (e.g., the display device 760, the sensor module 776, or the communication module 790) among the components of the electronic device 701, instead of the main processor 721 while the main processor 721 is in an inactive (e.g., sleep) state, or together with the main processor 721 while the main processor 721 is in an active state (e.g., executing an application). The auxiliary processor 723 (e.g., an image signal processor or a communication processor) may be implemented as part of another component (e.g., the camera module 780 or the communication module 790) functionally related to the auxiliary processor 723.

The memory 730 may store various data used by at least one component (e.g., the processor 720 or the sensor module 776) of the electronic device 701. The various data may include, for example, software (e.g., the program 740) and input data or output data for a command related thereto. The memory 730 may include the volatile memory 732 or the non-volatile memory 734.

The program 740 may be stored in the memory 730 as software, and may include, for example, an operating system (OS) 742, middleware 744, or an application 746.

The input device 750 may receive a command or data to be used by another component (e.g., the processor 720) of the electronic device 701, from the outside (e.g., a user) of the electronic device 701. The input device 750 may include, for example, a microphone, a mouse, or a keyboard.

The sound output device 755 may output sound signals to the outside of the electronic device 701. The sound output device 755 may include, for example, a speaker or a receiver. The speaker may be used for general purposes, such as playing multimedia or recording, and the receiver may be used for receiving an incoming call. The receiver may be implemented as being separate from, or a part of, the speaker.

The display device 760 may visually provide information to the outside (e.g., a user) of the electronic device 701. The display device 760 may include, for example, a display, a hologram device, or a projector and control circuitry to control a corresponding one of the display, hologram device, and projector. The display device 760 may include touch circuitry adapted to detect a touch, or sensor circuitry (e.g., a pressure sensor) adapted to measure the intensity of force incurred by the touch. The display device 760 may include the front-facing display device of the smartphone device described above with respect to FIGS. 2-6

The audio module 770 may convert a sound into an electrical signal and vice versa. The audio module 770 may obtain the sound via the input device 750 or output the sound via the sound output device 755 or a headphone of an external electronic device 702 directly (e.g., wired) or wirelessly coupled with the electronic device 701.

The sensor module 776 may detect an operational state (e.g., power or temperature) of the electronic device 701 or an environmental state (e.g., a state of a user) external to the electronic device 701, and then generate an electrical signal or data value corresponding to the detected state. The sensor module 776 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor. The sensor module 776 may include the accelerometers 202, 302, 402, and 502, the gyroscopes 204, 304, 404, and 504, and the front-facing EO sensors 424 and 524 of FIGS. 2-6 described above.

The interface 777 may support one or more specified protocols to be used for the electronic device 701 to be coupled with the external electronic device 702 directly (e.g., wired) or wirelessly. The interface 777 may include, for example, a high-definition multimedia interface (HDMI), a universal serial bus (USB) interface, a secure digital (SD) card interface, or an audio interface.

A connecting terminal 778 may include a connector via which the electronic device 701 may be physically connected with the external electronic device 702. The connecting terminal 778 may include, for example, an HDMI connector, a USB connector, an SD card connector, or an audio connector (e.g., a headphone connector).

The haptic module 779 may convert an electrical signal into a mechanical stimulus (e.g., a vibration or a movement) or an electrical stimulus which may be recognized by a user via tactile sensation or kinesthetic sensation. The haptic module 779 may include, for example, a motor, a piezoelectric element, or an electrical stimulator.

The camera module 780 may capture a still image or moving images. The camera module 780 may include one or more lenses, image sensors, image signal processors, or flashes. The power management module 788 may manage power supplied to the electronic device 701. The power management module 788 may be implemented as at least part of, for example, a power management integrated circuit (PMIC).

The battery 789 may supply power to at least one component of the electronic device 701. The battery 789 may include, for example, a primary cell which is not rechargeable, a secondary cell which is rechargeable, or a fuel cell.

The communication module 790 may support establishing a direct (e.g., wired) communication channel or a wireless communication channel between the electronic device 701 and the external electronic device (e.g., the electronic device 702, the electronic device 704, or the server 708) and performing communication via the established communication channel. The communication module 790 may include one or more communication processors that are operable independently from the processor 720 (e.g., the AP) and supports a direct (e.g., wired) communication or a wireless communication. The communication module 790 may include a wireless communication module 792 (e.g., a cellular communication module, a short-range wireless communication module, or a global navigation satellite system (GNSS) communication module) or a wired communication module 794 (e.g., a local area network (LAN) communication module or a power line communication (PLC) module). A corresponding one of these communication modules may communicate with the external electronic device via the first network 798 (e.g., a short-range communication network, such as Bluetooth™, wireless-fidelity (Wi-Fi) direct, or a standard of the Infrared Data Association (IrDA)) or the second network 799 (e.g., a long-range communication network, such as a cellular network, the Internet, or a computer network (e.g., LAN or wide area network (WAN)). These various types of communication modules may be implemented as a single component (e.g., a single IC), or may be implemented as multiple components (e.g., multiple ICs) that are separate from each other. The wireless communication module 792 may identify and authenticate the electronic device 701 in a communication network, such as the first network 798 or the second network 799, using subscriber information (e.g., international mobile subscriber identity (IMSI)) stored in the subscriber identification module 796.

The antenna module 797 may transmit or receive a signal or power to or from the outside (e.g., the external electronic device) of the electronic device 701. The antenna module 797 may include one or more antennas, and, therefrom, at least one antenna appropriate for a communication scheme used in the communication network, such as the first network 798 or the second network 799, may be selected, for example, by the communication module 790 (e.g., the wireless communication module 792). The signal or the power may then be transmitted or received between the communication module 790 and the external electronic device via the selected at least one antenna.

Commands or data may be transmitted or received between the electronic device 701 and the external electronic device 704 via the server 708 coupled with the second network 799. Each of the electronic devices 702 and 704 may be a device of a same type as, or a different type, from the electronic device 701. All or some of operations to be executed at the electronic device 701 may be executed at one or more of the external electronic devices 702, 704, or 708. For example, if the electronic device 701 should perform a function or a service automatically, or in response to a request from a user or another device, the electronic device 701, instead of, or in addition to, executing the function or the service, may request the one or more external electronic devices to perform at least part of the function or the service. The one or more external electronic devices receiving the request may perform the at least part of the function or the service requested, or an additional function or an additional service related to the request and transfer an outcome of the performing to the electronic device 701. The electronic device 701 may provide the outcome, with or without further processing of the outcome, as at least part of a reply to the request. To that end, a cloud computing, distributed computing, or client-server computing technology may be used, for example.

Embodiments of the subject matter and the operations described in this specification may be implemented in digital electronic circuitry, or in computer software, firmware, or hardware, including the structures disclosed in this specification and their structural equivalents, or in combinations of one or more of them. Embodiments of the subject matter described in this specification may be implemented as one or more computer programs, i.e.., one or more modules of computer-program instructions, encoded on computer-storage medium for execution by, or to control the operation of data-processing apparatus. Alternatively or additionally, the program instructions can be encoded on an artificially-generated propagated signal, e.g., a machine-generated electrical, optical, or electromagnetic signal, which is generated to encode information for transmission to suitable receiver apparatus for execution by a data processing apparatus. A computer-storage medium can be, or be included in, a computer-readable storage device, a computer-readable storage substrate, a random or serial-access memory array or device, or a combination thereof. Moreover, while a computer-storage medium is not a propagated signal, a computer-storage medium may be a source or destination of computer-program instructions encoded in an artificially-generated propagated signal. The computer-storage medium can also be, or be included in, one or more separate physical components or media (e.g., multiple CDs, disks, or other storage devices). Additionally, the operations described in this specification may be implemented as operations performed by a data-processing apparatus on data stored on one or more computer-readable storage devices or received from other sources.

While this specification may contain many specific implementation details, the implementation details should not be construed as limitations on the scope of any claimed subject matter, but rather be construed as descriptions of features specific to particular embodiments. Certain features that are described in this specification in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described herein. Other embodiments are within the scope of the following claims. In some cases, the actions set forth in the claims may be performed in a different order and still achieve desirable results. Additionally, the processes depicted in the accompanying figures do not necessarily require the particular order shown, or sequential order, to achieve desirable results. In certain implementations, multitasking and parallel processing may be advantageous.

As will be recognized by those skilled in the art, the innovative concepts described herein may be modified and varied over a wide range of applications. Accordingly, the scope of claimed subject matter should not be limited to any of the specific exemplary teachings discussed above, but is instead defined by the following claims.

What is claimed is:

1. A method comprising:
acquiring observations by one or more electro-optical (EO) sensors on a front-facing surface of a user equipment (UE);
extracting, by a processor of the UE, feature points from the observations expressed in a first coordinate frame of the UE; and
matching, by the processor, the feature points to corresponding points of a model in a second coordinate frame of a user of the UE; and
determining, by the processor, an integrated navigation solution in a third coordinate frame based on the matched feature points.

2. The method of claim 1, wherein the integrated navigation solution is determined based on motion constraints of the user in the second coordinate frame.

3. The method of claim 1, further comprising:
determining a pose transformation between the first coordinate frame and the second coordinate frame, based on the matched feature points, wherein the integrated navigation solution is determined based on the pose transformation.

4. The method of claim 1, further comprising:
acquiring inertial measurements in the first coordinate frame using one or more inertial navigation system (INS) devices of the UE; and
determining, by the processor, an inertial navigation solution in a third coordinate frame based on the inertial measurements, wherein the integrated navigation solution is determined based on the inertial navigation solution.

5. The method of claim 4, wherein the one or more INS devices comprise at least one of an accelerometer or a gyroscope.

6. The method of claim 1, wherein the integrated navigation solution is determined based on navigational measurements.

7. The method of claim 6, wherein the navigational measurements comprise ranging measurements or global navigation satellite system (GNSS) measurements.

8. The method of claim 1, wherein the integrated navigation solution comprises at least a position, a velocity, or an attitude of the user.

9. The method of claim 8, wherein the integrated navigation solution further comprises at least one of INS bias, GNSS receive clock bias or drift, a pose transformation between the first coordinate frame and the second coordinate frame, and a map of the environment.

10. The method of claim 1, wherein the model is a three-dimensional (3D) model of a face of the user or an interior of a vehicle, and the 3D model is prestored prior to capturing the image or estimated in a simultaneous localization and mapping (SLAM) approach after capturing the image.

11. A user equipment (UE) comprising:
a front-facing surface;
one or more electro-optical (EO) sensors on the front-facing surface of the UE acquiring observations;
one or more inertial navigation system (INS) devices outputting inertial measurements of the UE in a first coordinate frame of the UE;
a processor configured to:
extract feature points from the observations expressed in the first coordinate frame;
match the feature points to corresponding points of a model in a second coordinate frame of a user of the UE; and
determine an integrated navigation solution in a third coordinate frame based on the matched feature points.

12. The UE of claim 11, wherein the integrated navigation solution is determined based on motion constraints of the user in the second coordinate frame.

13. The UE of claim 11, wherein the processor is further configured to:
determine a pose transformation between the first coordinate frame and the second coordinate frame, based on the matched feature points, wherein the integrated navigation solution is determined based on the pose transformation.

14. The UE of claim 11, wherein the processor is further configured to determine an inertial navigation solution in a third coordinate frame based on the inertial measurements, wherein the integrated navigation solution is determined based on the inertial navigation solution.

15. The UE of claim 11, wherein the one or more INS devices comprise at least one of an accelerometer or a gyroscope.

16. The UE of claim 11, wherein the integrated navigation solution is determined based on navigational measurements, and the navigational measurements comprise ranging measurements or global navigation satellite system (GNSS) measurements.

17. The UE of claim 11, wherein the integrated navigation solution comprises at least a position, a velocity, or an attitude of the user.

18. The UE of claim 17, wherein the integrated navigation solution further comprises at least one of INS bias, GNSS receive clock bias and drift, a pose transformation between the first coordinate frame and the second coordinate frame, or a map of the environment.

19. The UE of claim 11, wherein the model is a three-dimensional (3D) model of a face of the user or an interior of a vehicle, and the 3D model is prestored prior to capturing the image or estimated simultaneous localization and mapping (SLAM) approach after capturing the image.

20. A user equipment (UE) comprising:
a processor; and
a non-transitory computer readable storage medium storing instructions that, when executed, cause the processor to:
control one or more electro-optical (EO) sensors on a front-facing surface of the UE to acquire observations;
extract feature points from the observations expressed in a first coordinate frame of the UE;
matching the feature points to corresponding points of a model in a second coordinate frame of a user of the UE; and
determine an integrated navigation solution in a third coordinate frame based on the matched feature points.
